(19) United States
(12) Patent Application Publication
(10) Pub. No.: US 2004/0101613 A1
(43) Pub. Date: May 27, 2004

(54) Reduced sourness emulsion

(75) Inventor: Guy Levi, Wyckoff, NJ (US)

Correspondence Address: UNILEVER, PATENT DEPARTMENT, 45 RIVER ROAD, EDGEWATER, NJ, 07020, US

(73) Assignee: Unilever Bestfoods North America

(21) Appl. No.: 10/305,577

(22) Filed: Nov. 27, 2002

(51) Int. Cl. A23D 7/00

(52) U.S. Cl. 426/601

(57) ABSTRACT

The invention is directed to w/o/w emulsions that are microbiologically stable and free of a distinct sour taste. The w/o/w emulsions have at least about 50% by weight of the total amount of acidulant utilized in the emulsion within the primary phase. The w/o/w emulsion of this invention can be used as a base for a variety of end use products.

### FIELD OF THE INVENTION

The present invention is directed to a microbiologically stable emulsion that does not have a distinct sour taste. More particularly, this invention is directed to a water-in-oil-in-water (w/o/w) emulsion wherein at least about 50% by weight of the total amount of acidulant utilized in the emulsion is present in the primary phase. The w/o/w emulsion of this invention can, unexpectedly, be light, low-fat or non-fat and formulated to have an acceptable dressing viscosity without delivering a sour taste to the consumer.

### BACKGROUND OF THE INVENTION

Edible water-in-oil-in-water emulsions (w/o/w) comprising an external water phase and a dispersed phase having water-in-oil have been made. Such w/o/w emulsions are often desired because low or reduced fat formulations can be made to have rheologies that mimic the rheology and other fat related characteristics of substantially higher fat formulations.

When less fat is employed in any emulsion, especially an edible emulsion, water and water soluble thickening agents are typically used to replace the fat and more acidulant is required in order to minimize microbiological safety concerns generally associated with a composition having a high water content. Unfortunately, when an emulsion is made with reduced fat, high water content and high levels of acidulant, the resulting emulsion tends to have an acidic or sour taste that is not pleasing to the consumer. In view of this, many of the efforts made to formulate edible emulsions that taste good and are low in fat are unsuccessful.

It is of increasing interest to develop an edible emulsion that is microbiologically stable, light, low-fat or non-fat, of acceptable viscosity and suitable to deliver a pleasing (non-sour) taste to the consumer. This invention, therefore, is directed to a reduced sourness w/o/w emulsion wherein at least about 50% by weight of the total amount of acidulant utilized in the emulsion is present in the primary phase.

### Additional Information

Efforts have been disclosed for making emulsions. In U.S. Pat. No. 4,933,192, hydratable powders which form w/o/w emulsions are described.

Other efforts have been disclosed for making emulsions. In U.S. Pat. No. 5,683,737, mayonnaise and dressing compositions having a glucono-delta-lactone preservative system are disclosed.

Still other efforts have been disclosed for making emulsions. In European Patent Application Nos. EP 0 997 074 A1 and EP 0 997 075 A1, edible emulsions are described.

None of the information above describes a w/o/w emulsion wherein at least about 50% by weight of the total acidulant utilized in the w/o/w emulsion is present in the primary phase.

### SUMMARY OF THE INVENTION

In a first aspect, the present invention is directed to a w/o/w emulsion comprising:

(a) a primary phase comprising a water-in-oil emulsion; and

(b) an external aqueous phase,

the w/o/w emulsion has an amount of water in the primary phase (W1) and in the external aqueous phase (W2), and an amount of acidulant in the primary phase (A1) and in the external aqueous phase (A2) wherein W1>W2 and A1>A2.

In a second aspect, the present invention is directed to a multiple emulsion comprising the w/o/w emulsion of the first aspect of this invention, including the w/o/w emulsion in oil.

In a third aspect, the present invention is directed to a food product comprising the w/o/w emulsion or multiple emulsion of the present invention.

In a fourth aspect, the present invention is directed to a method for making the w/o/w emulsion of the first aspect of this invention.

A w/o/w emulsion, as used herein, is defined to mean a water-in-oil-in-water emulsion with the internal water-in-oil emulsion being within or the primary phase and the external aqueous phase being the external continuous phase.

Primary phase, as used herein, means the internal phase of the w/o/w emulsion that can comprise, consist essentially of or consist of the water-in-oil emulsion described.

Stable means microbiologically stable (no mold growth) and no flavor loss for at least about nine (9) months, and preferably, for at least about ten (10) months when kept in a covered (i.e., sealed) package at about ambient temperature.

Reduced sourness means tasting less sour than conventional reduced fat (<65%) edible oil-in-water emulsions.

Amount of acidulant means actual weight of 100 percent acidulant, not an acidulant solution.

Emulsions that are light and low-fat are meant to mean the same, and that is, between about 10.⁰% to about 35.0% by weight oil, based on total weight of the emulsion. Fat free emulsions are defined to mean emulsions with less than about 6.0% by weight oil. Oil means comprising triglycerides, and especially, those that are liquids at ambient temperature.

Viscosity, as used herein means deformation properties obtained with a Haake Rheometer equipped with a set of concentric, bob-in-cup, cylinders (3 mm gap) wherein the bob employed has a diameter of 30.4 mm, the cup has a diameter of 42 mm, and shearing occurs by ramping cylinder oscillation at a rate from 0 to 135 reciprocal seconds at ambient temperature. Viscosity reported is taken at a shear rate of 10 reciprocal seconds.

### DETAILED DESCRIPTION OF THE PREFERRED EMBODIMENTS

There is no limitation with respect to the oil used in the primary phase of the w/o/w emulsion of the present invention as long as the oil is suitable for human consumption. Illustrative examples of the oil which may be used in this invention include avocado, coconut, corn, cottonseed, fish oil, flaxseed, grape, olive, palm, peanut, rapeseed, safflower, sesame, soybean, sunflower oil, mixtures thereof and the like. In a preferred embodiment, the oil used in this invention is soybean oil.

When preparing the water-in-oil emulsion of the primary phase of the w/o/w emulsion of this invention, from about 0.01 to about 12.0%, and preferably, from about 0.1 to about 10.0%, and most preferably, from about 1.0 to about 5.0% by weight primary emulsifier is used, based on total weight of the primary phase, and including all ranges subsumed therein. Typically, primary emulsifier (i.e., emulsifier selected for use in the primary phase) is added (preferably with stirring and heating) to the oil, and an oil and primary emulsifier mixture is obtained. Water is usually added (with stirring) to oil at about ambient temperature after the primary emulsifier has been completely dissolved in the oil to produce the primary emulsion of the primary phase. The amount of water added to the primary phase (W1) is such that the amount added is greater than the amount of water in the external aqueous phase (W2) of the desired w/o/w emulsion, and preferably, from about 55.0 to about 90.0%, and most preferably, from about 60.0 to about 75.0% of the total weight of water in the w/o/w emulsion is in the primary phase.

The primary emulsifier used in the w/o/w emulsion of the present invention typically has a hydrophilic-lypophilic number (HLB) of less than about 9.0, and preferably, less than about 6.5, and most preferably, from about 1.0 to about 4.0, including all ranges subsumed therein. Illustrative examples of the primary emulsifiers that can be used in the primary phase of this invention include nonionics like cetyl and stearyl trioleate, tristearate, sesquioleate, monoleate, monostearate, monopalmitate and monolaurate sorbitan (and derivatives thereof), all of which are made available under the name(s) Brij, Span and/or Tween by ICI Surfactants.

Other primary emulsifiers that may be used in this invention include nonionic copolymers of ethylene oxide and propylene oxide made available under the name Pluronic by BASF AG. Even other primary emulsifiers that may be used in this invention include lecithin and mono- and diglycerides, as well as polyglycerol polyricinoleate (PGPR). The preferred primary emulsifier used in this invention is PGPR.

The external phase emulsifier (i.e., emulsifier used in the external phase) used in this invention often has an HLB of greater than about 9.0, and preferably, greater than about 11.0, and most preferably, from about 12.0 to about 18.0, including all ranges subsumed therein. Such an emulsifier can be added to and dissolved in water to produce an external phase mixture. Examples of the external phase emulsifier suitable for use in this invention include PEG 20 tristearate, PEG 20 trioleate, PEG 20 monostearate, PEG 20 monooleate, PEG 20 monopalmitate and PEG 20 monolaurate sorbitan, derivatives thereof, mixtures thereof and the like, also made available by ICI Surfactants under the names Tween or Span. The preferred external phase emulsifier employable in this invention is, however, a phospholipoprotein, and especially, egg yolk derived phospholipoprotein modified with phospholipase A as disclosed in U.S. Pat. No. 5,028,447, the disclosure of which is incorporated herein by reference.

The amount of external phase emulsifier employed in the w/o/w emulsion of this invention is typically from about 1.0 to about 7.0%, and preferably, from about 1.5% to about 6.0%, and most preferably, from about 3.0 to about 5.5% by weight external phase emulsifier, based on total weight of the w/o/w emulsion and including all ranges subsumed therein.

Subsequent to preparing the primary emulsion and the external phase mixture, the primary emulsion may be added to the external phase mixture, preferably while stirring. The resulting rough w/o/w emulsion may then be fed to a size reducing and mixing apparatus such as a conventional homogenizer, colloid mill, sonicator, cross-flow membrane emulsifier, static mixer, or microfluidation device. In a preferred embodiment, the rough w/o/w emulsion is fed through a colloid mill and the w/o/w emulsion produced has oil droplets having diameters that are from about 5.0 to about 35.0, and preferably, from about 6.0 to about 25.0, and most preferably, from about 7.0 to about 15.0 microns, including all ranges subsumed therein. The water droplets of the primary phase water-in-oil emulsion produced have diameters that are from about 0.5 to about 6.0, and preferably, from about 1.0 to about 5.0, and most preferably, from about 1.0 to about 4.0 microns, including all ranges subsumed therein. In an especially preferred embodiment, the primary emulsion is subjected to a size reducing apparatus (so that the primary phase droplets are about 1.0 to about 4.0 microns in diameter) before being combined with the external phase mixture. The resulting desired reduced sourness w/o/w emulsion typically has a viscosity from about 10,000 to about 150,000, and preferably, from about 30,000 to about 130,000, and most preferably, from about 60,000 to about 100,000 cps.

In an especially preferred embodiment, acidulant is added to the water in both the primary phase and the external aqueous phase prior to the formation of the w/o/w emulsion. Typically, at least about 50.0%, and preferably, at least about 55.0 to 65.0% by weight of acidulant is added in to the primary phase, based on total weight of acidulant used in the reduced sourness w/o/w emulsion of this invention. The amount of acidulant employed in the w/o/w emulsion of the present invention is typically from about 0.1 to about 0.8%, and preferably, from about 0.2 to about 0.6%, and most preferably, from about 0.25 to about 0.45% by weight acidulant, based on total weight of the w/o/w emulsion and including all ranges subsumed therein. In yet another preferred embodiment, the concentration of free hydrogen for the acid employed is greater in the external aqueous phase. There is essentially no limitation with respect to the type of acidulant used in the w/o/w emulsion of the present invention other than that the acidulant is suitable for use in an edible composition. Illustrative acidulants that may be used in this invention include acetic acid (i.e., vinegar), lactic acid, tartaric acid, hydrochloric acid, malic acid, phosphoric acid, mixtures thereof and the like.

Optional additives that may be employed in the emulsion of this invention include artificial and natural food grade flavors and colors; protein powders like whey protein; thickening agents like microcrystalline cellulose, pectin, xanthan gum, guar gum, starch (including cook-up and cold water starches); and preservatives like sorbic acid, sodium benzoate, potassium benzoate, potassium sorbate and glucono-delta-lactone. Still other optional additives that may be employed in the reduced sourness w/o/w emulsion of this invention include spices like salt, sugar, ginger, nutmeg, basil, cinnamon, onion, garlic and pepper; pieces or particulates of meats (like ham, bacon, pork, fish, poultry), vegetables (like carrots, celery, cabbage, cucumbers), potato, macaroni or combinations thereof.

In a preferred embodiment, when optional additives are employed, those that are water soluble are added to the water in the primary phase, the water in the external phase, or both; and the optional additives that are not water soluble are preferably only added in the external phase. In an especially preferred embodiment, primary phase and external phase concentration ratios of salt and sugar are maintained so that no appreciable change in water droplet diameter size is observed.

When optional additives are employed, they typically make up less than about 12.0% by weight of the total weight of the w/o/w emulsion, and preferably, from about 0.1% to about 10.0% by weight of the total weight of the w/o/w emulsion.

There is essentially no limitation to the types of food compositions that may employ the reduced sourness w/o/w emulsion of the present invention. Therefore, such a w/o/w emulsion can be used as a base for hot, Hollandaise, Alfredo and Bernaise sauces. The reduced sourness w/o/w emulsion of this invention may also be used in dressings for salads as well as a base for light, low-fat and fat-free mayonnaises and dips.

The following examples are provided to facilitate an understanding of the present invention. The examples are not intended to limit the scope of the claims.

### EXAMPLE 1

Primary emulsion was made by mixing the following ingredients under moderate shear. Oil and emulsifier were mixed first, followed by the addition of the remaining ingredients.

| | Wt. % based | Wt. % based |
|---|---|---|
| | on total weight | on total weight |
| Ingredient | of primary emulsion | of w/o/w emulsion |
| Oil | 38.8 | 30.0 |
| Emulsifier (PGPR) | 2.7 | 2.1 |
| Water | 53.9 | 41.7 |
| Vinegar | 2.0 | 1.6 |
| Salt | 1.3 | 1.0 |
| Sugar | 1.3 | 1.0 |
| Total | 100.0 | 77.4 |

### EXAMPLE 2

External phase mixture was prepared by mixing the following ingredients under moderate shear:

| | Wt. % based | Wt. % based |
|---|---|---|
| | on total weight of | on total weight of |
| Ingredient | external phase mixture | of w/o/w emulsion |
| Modified egg emulsifier | 21.2 | 5.0 |
| Starch | 4.2 | 1.0 |
| Xanthan gum | 0.1 | 0.023 |
| Vinegar | 6.4 | 1.5 |
| Salt | 4.2 | 1.0 |
| Sugar | 7.6 | 1.8 |
| Water | 56.3 | 13.3 |
| Total | 100.0 | 23.6 |

### EXAMPLE 3

The w/o/w emulsion of the present invention was prepared by slowly adding and mixing the primary emulsion of Example 1 to the external phase mixture of Example 2, producing a rough w/o/w emulsion. The rough w/o/w emulsion was fed to a commercially available Charlotte® colloid mill to produce a reduced sourness emulsion with a dispersed primary aqueous phase having droplets with diameters from about 1 to about 4 microns and oil droplets having diameters from about 7 to about 30 microns.

### EXAMPLE 4

About twenty-four (24) sealed sixteen (16) oz. jars comprising w/o/w emulsion similar to the one made in Example 3 were stored at ambient temperature. After about ten (10) months, mold growth and flavor loss were not observed.

### EXAMPLE 5

Reduced sourness w/o/w emulsion similar to the one made in Example 3 may be compared to a low-fat single aqueous phase oil-in-water emulsion utilized in conventional low-fat mayonnaise products. Panelist who sample the w/o/w emulsion of this invention and the single aqueous phase oil-in-water emulsion used in commercially available low-fat mayonnaise products will conclude that the w/o/w emulsion of this invention is less sour than the conventional low-fat single aqueous phase oil-in-water emulsion.

The results obtainable above indicate that the superior w/o/w emulsion of the present invention is microbiologically stable and better tasting than conventional emulsions, even with high water levels.

1. A w/o/w emulsion comprising:
(a) a primary phase comprising a water-in-oil emulsion; and
(b) an external aqueous phase,
the w/o/w emulsion has an amount of water in the primary phase (W1) and in the external aqueous phase (W2), and an amount of acidulant in the primary phase (A1) and in the external aqueous phase (A2) wherein W1>W2 and A1>A2.

2. The w/o/w emulsion according to claim 1 wherein the w/o/w emulsion has a total weight of water, and the primary phase comprises from about 55.0% to about 90.0% of the total weight of water.

3. The w/o/w emulsion according to claim 1 wherein the primary phase comprises an emulsifier having an HLB of less than about 9.

4. The w/o/w emulsion according to claim 1 wherein the external aqueous phase has an emulsifier having an HLB of greater than about 9.

5. The w/o/w emulsion according to claim 3 wherein the emulsifier is polyglycerol polyricinoleate.

6. The w/o/w emulsion according to claim 4 wherein the emulsifier is a phospholipoprotein modified with phospholipase A.

7. The w/o/w emulsion according to claim 1 wherein the w/o/w emulsion has a viscosity from about 10,000 to about 150,000 cps.

8. The w/o/w emulsion according to claim 1 wherein the w/o/w emulsion has a total amount of acidulant, and the primary phase comprises from about 55.0% to about 60.0% of the total amount of acidulant in the w/o/w emulsion.

9. The w/o/w emulsion according to claim 1 wherein the w/o/w emulsion is stable for at least about nine (9) months.

10. The w/o/w emulsion according to claim 1 wherein the w/o/w emulsion does not comprise a distinct sour taste.

11. The w/o/w emulsion according to claim 1 wherein the w/o/w emulsion is suitable to make a multiple emulsion when added to oil and emulsifier.

12. The w/o/w emulsion according to claim 1 wherein the external aqueous phase has a free hydrogen concentration that is greater than free hydrogen concentration of the primary phase.

13. A food composition comprising a w/o/w emulsion comprising:
(a) a primary phase comprising a water-in-oil emulsion; and
(b) an external aqueous phase,
the w/o/w emulsion has an amount of water in the primary phase (W1) and in the external aqueous phase (W2), and an amount of acidulant in the primary phase (A1) and in the external aqueous phase (A2) wherein W1>W2 and A1>A2.

14. The food composition according to claim 13 wherein the food composition is a hot, Hollandaise, Alfredo or Bernaise sauce.

15. The food composition according to claim 13 wherein the food composition is a salad dressing or mayonnaise.

16. A method for making a w/o/w emulsion comprising, in no particular order, the steps of:
(a) making a water-in-oil emulsion with an amount of acidulant;
(b) making a water and emulsifier external phase mixture with an amount of acidulant
wherein the amount of acidulant in the water-in-oil emulsion is greater than the amount of acidulant in the external phase mixture, and the water-in-oil emulsion is mixed with the external phase mixture.

17. The method according to claim 16 wherein the external phase mixture has less water than the water-in-oil emulsion.

18. The method according to claim 16 wherein the w/o/w emulsion comprises from about 0.1 to about 0.8% by weight acidulant.

19. A w/o/w emulsion comprising:
(a) a primary phase comprising a water-in-oil emulsion; and
(b) an external aqueous phase
wherein the external aqueous phase comprises a free hydrogen concentration that is greater than free hydrogen concentration of the primary phase.

20. The w/o/w emulsion according to claim 19 wherein the w/o/w emulsion is emulsified in a multiple emulsion.
